(19) United States
(12) Patent Application Publication
(10) Pub. No.: US 2014/0019960 A1
(43) Pub. Date: Jan. 16, 2014

(54) SYSTEMS AND METHODS OF CREATING CUSTOM VIRTUAL MACHINES

(71) Applicants: Mark Jacklin, Berkshire (GB); Justin How, Slough (GB); David Falkus, Twyford (GB)

(72) Inventors: Mark Jacklin, Berkshire (GB); Justin How, Slough (GB); David Falkus, Twyford (GB)

(73) Assignee: MICROSOFT CORPORATION, Redmond, WA (US)

(21) Appl. No.: 13/547,636

(22) Filed: Jul. 12, 2012

(51) Int. Cl. G06F 9/46; G06F 3/048; G06F 9/455

(52) U.S. Cl. 718/1

(57) ABSTRACT

Systems and techniques of the creation of Virtual Machines (VM) from user requests to a Virtual Takeaway (VT) system are presented. In one embodiment, the VT system comprises a website to which the user may make requests for either pre-defined VM builds or customized VM builds. The VT system may also comprise a set of virtualization servers to which the requests for VM may be affected. In addition, the VT system may comprises a VT controller which may schedule jobs for the completion of user requests, to keep track of status of the state of various VM build requests and to perform administrative jobs for the efficient operation of the system.

### BACKGROUND

Current and prior offerings around self-service portals for Virtual Machine (VM) creation tend to provide only simple options in terms of the complexity of the types of virtual machine from which the user may choose. Often, this simple option is purely the OS install and, as such, this leaves the end-user with having to find and install all the usual pre-requisite files and applications before the users have a machine in the state ready to use.

For the user, this tends to be a complex and time consuming activity which demands a level of constant interaction with the install processes as well as expert knowledge about the order of installation and best practices in terms of configuration. Typically, the process is one of trial and error, even if following a manual guide as they are prone to becoming quickly out of date as products are updated and configurations are modified.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Systems and techniques of the creation of Virtual Machines (VM) from user requests to a Virtual Takeaway (VT) system are presented. In one embodiment, the VT system comprises a website to which the user may make requests for either pre-defined VM builds or customized VM builds. The VT system may also comprise a set of virtualization servers to which the requests for VM may be affected. In addition, the VT system may comprises a VT controller which may schedule jobs for the completion of user requests, to keep track of status of the state of various VM build requests and to perform administrative jobs for the efficient operation of the system.

In one embodiment, a method for creating virtual machines (VMs) from user requests to a VT system is disclosed. The VT system may comprise a user interface, a set of virtualization servers, and a VT controller for controlling VM build processes within said VT system. The steps of said method may comprise: receiving a user request for a VM build; checking the validity of said user request for said VM build; scheduling said VM build job by said VT controller; building said VM build according to said user request; and scheduling administrative jobs for said virtualization servers.

In another embodiment, a system for creating VM from user requests is disclosed. The system may comprise: a VT website, said VT website capable of presenting users with a main menu of options for a user to select a desired VM to build; a set of virtualization servers, said virtualization servers capable of building VMs according to the specification supplied by said user; a VT controller, in communications with said set of virtualization servers, wherein said VT controller is capable of testing user requests for VM builds and scheduling jobs to affect said VM builds.

Other features and aspects of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 depicts one embodiment of a Virtual Takeaway (VT) computer system made in accordance with the principles of the present application.

FIG. 2 is one embodiment of a flowchart of a VT process as made in accordance with the principles of the present application.

FIG. 3 is one embodiment of main menu of a VT system as it might be presented to the user.

FIG. 4 is one embodiment of a user menu for building pre-defined virtual machines as it might be presented to the user by the VT system.

FIG. 5 is one embodiment of a user menu for the building of customized virtual machines as it might be presented to the user by the VT system.

FIG. 6 is one embodiment of a flowchart of a VT routine to manage one or more Hyper-V servers in a VT system.

### DETAILED DESCRIPTION

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

### INTRODUCTION

In many embodiments, systems, methods and techniques are presented herein such that a user may be able to select from either a list of pre-defined complex VM builds or may make their own custom complex VM build using a simple menu system. In many embodiments, these user/customer/consumer builds may be independent of the user's OS wherever possible. In many of the embodiments presented herein, users may request the creation of either a workgroup-based VM or a domain controller which may allow products with an Active Directory dependency to be installed.

In one embodiment, the user may be able to select either a single machine using a standard web interface or may be able to create multiple virtual machines through the use of a definition file (e.g., XML). Users in one embodiment may be able to replace the data in the definition file—which might have been supplied through the web interface.

The build of the VM may be accomplished in the background without user involvement using a library of scripts and configuration data—for example, as might be defined with an Automatic Purposing Framework (APF) software and toolset, as produced by the Microsoft Corporation of Redmond, Wash. Co-owned U.S. Pat. No. 7,496,890 (the '890 patent), issued on Feb. 24, 2009 to Miller et al. and entitled “GENERATION OF CONFIGURATION INSTRUCTIONS USING AN ABSTRACTION TECHNIQUE” describes such an APF framework—and is hereby incorporated by reference herein in its entirety.

A virtual machine may be automatically updated with all the latest updates (as provided, for example by Microsoft Update® software) such that the user may have the most up to date version when it is built. In another embodiment, systems may deploy virtual machines directly to a cloud-based platform—say for example, Microsoft Windows Azure® platform—using the same concepts as above but using the security procedures to upload the image to a user's storage account on such cloud-based platform—e.g., Windows Azure® platform.

In one embodiment, there may be little or no user interaction once the build process has been initiated and, at the end, the VM may be either automatically downloaded to a user-defined location or a link may be sent notifying the users where to download the VM.

### One Embodiment

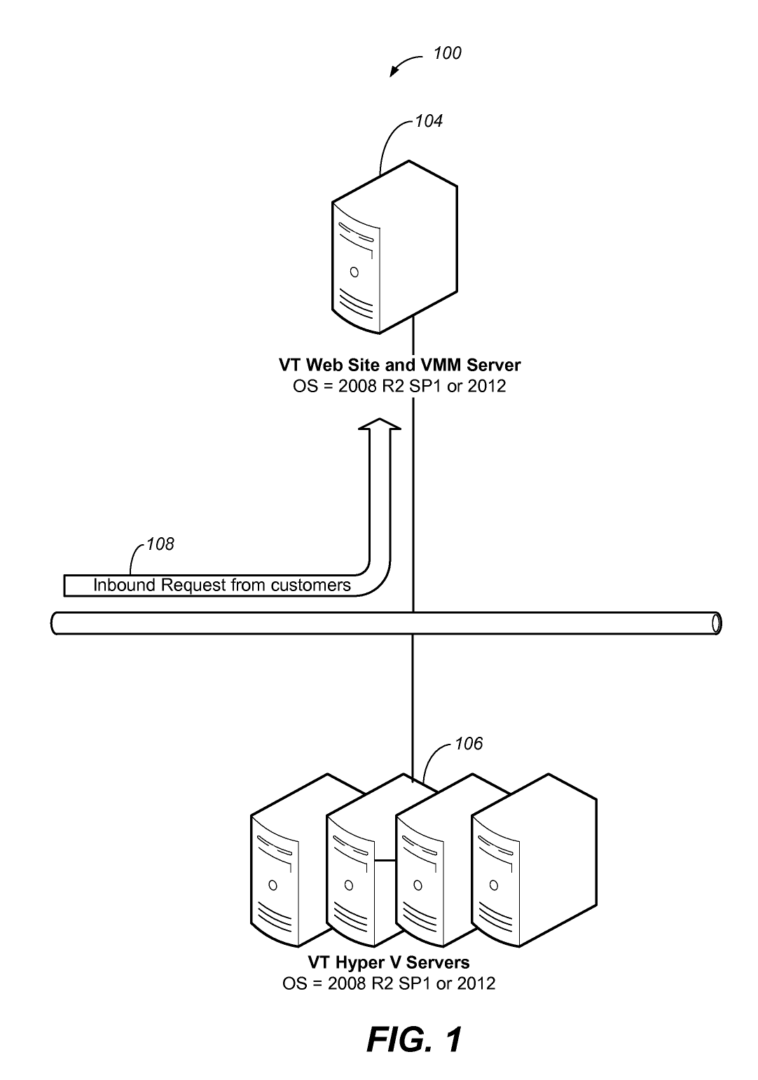

FIG. 1 depicts one exemplary environment in which systems and/or methods (also termed “Virtual Takeaway” or “VT” herein) made in accordance with the principles of the present application may be implemented. System 100 may comprise a VT website and Virtual Machine Manager (“VMM”, “SCVMM” or otherwise called the VT controller) server 104, and VT Hyper-V servers 106, in communication with each other. It will be appreciated that Hyper-V servers may also be affected by any suitable virtualization servers and/or routines (processes) running on suitable hardware that may affect a partition of a computing environment. It will also be appreciated that the VT website may be separate from, or managed by, the VMM and/or VT controller.

VMM server 104 may run scheduled tasks (e.g., as PowerShell scripts). Server 104 may also control the servers 106. Servers 106 may affect the actual VM builds and—as discussed further herein—may hold finished files and work product for a given period of time for the user to download. Other scheduled task may perform administrative jobs for the virtualization servers, as discussed further herein. As seen in FIG. 1, inbound requests 108 for VM creation may enter the system and be handled initially by the VMM server 104.

In one embodiment, the system may also comprise three main parts:
(1) Web portal—this may be a custom website which displays the virtual machine build options for the end-users to choose from and then uses a custom HTTP handler to allow the calling of Powershell directly from the web pages to initiate the builds and communicate directly with Microsoft System Centre Virtual Machine Manager (SCVMM).
(2) Microsoft System Center Virtual Machine Manager and Hyper-V—these two components provide the virtualization layer used during the build process.
(3) Build definitions, scripts and images to perform the installation—these are the building blocks of the VT system which are called via the web portal and control the actual process of building out the virtual machines and the administration of the overall process.

Overview of the Service

The Virtual Takeaway may utilize the functionality of Virtual Machine Manager to automatically provision custom virtual machines (and environments) on either Hyper-V or Virtual Server. In one embodiment, the VT system may be designed to allow a user to request a fully built virtual machine (e.g., chosen from a simple menu) which may then be built by VT in the background over a period of time (e.g., approximately 1-6 hours, depending on the user request).

Once the VT machine has finished building, it may be desirable to have the VT system automatically shut down and move to a shared storage. The user may be notified by email that a Virtual Hard Disk (VHD) file is ready to be copied. It may also be desirable to delete these VHD files after a period of time (e.g., 3 working days) to stop the server running out of disk space. Optionally, it may be desirable to specify a file share that is local to the user to which the VHD may be automatically copied.

In one embodiment, VM requests may be customized to provide specific OS's and applications through a menu on the website. These requests may be take the following forms: (1) from a list of predefined workgroup Desktop and Server builds; (2) a workgroup Server OS with specific selected apps selected from a menu; (3) a workgroup Desktop OS with specific selected apps selected from a menu and/or (4) a customized Domain Controller with specific selected apps selected from a menu. In other embodiments, the VT may allow: (1) a workgroup Server OS with specific selected apps to be uploaded to a cloud store and/or platform (e.g. Azure platform); (2) a prepared Test Agent and Controller image to be uploaded to a cloud platform.

In an embodiment employing the “Self Service” functionality within VMM, the VT may differ in that the system may take an image (via Sysprep or the like) that consists of just the OS and may automatically install the desired applications at VT build time—rather than having them pre-loaded into the image.

In some embodiments, a website employed for the VT may use a custom in-house developed HTTP PowerShell handler. This would allow the VT system to embed PowerShell scripting within the web pages which is essential for the easy control of SCVMM. In addition, backend VMs may be built (i.e., after the OS VM is created) by an APF (as referenced in the '890 patent). This may configure the OS and layers on the applications.

### Embodiments Utilizing PowerShell Handler

In some embodiments, the VT website may use a PowerShell Handler that may allow the webpages to hold PowerShell script commands. This may be desirable to easily manipulate SCVMM and because it is a widely understood scripting language amongst IT administrators/consultants.

An example of the mixed HTML and PowerShell pages language is shown below:

```
If ($status1 -eq $false) {%>
  <tr style=”background-color: $BackGround” >
  <td><strong>$VMN</strong></td>
  <% if ($InQueue -eq “Yes”) {%>
    <td>In VT Queue</td>
    <td>In VT Queue</td>
  <% } Else { %?
    <td>No Log Yet</td>
    <td>APF Not Started</td>
  <% }
} elseif ($status1 -ne $false) {% >
```

In one embodiment, the system may allow one instance of a portion of script/html to exist and be used in many places within the site. For example, the VT menu is one file that may be “included” in many different files in the site. This may be desirable during system update, as only one file may be edited.

### One Embodiment

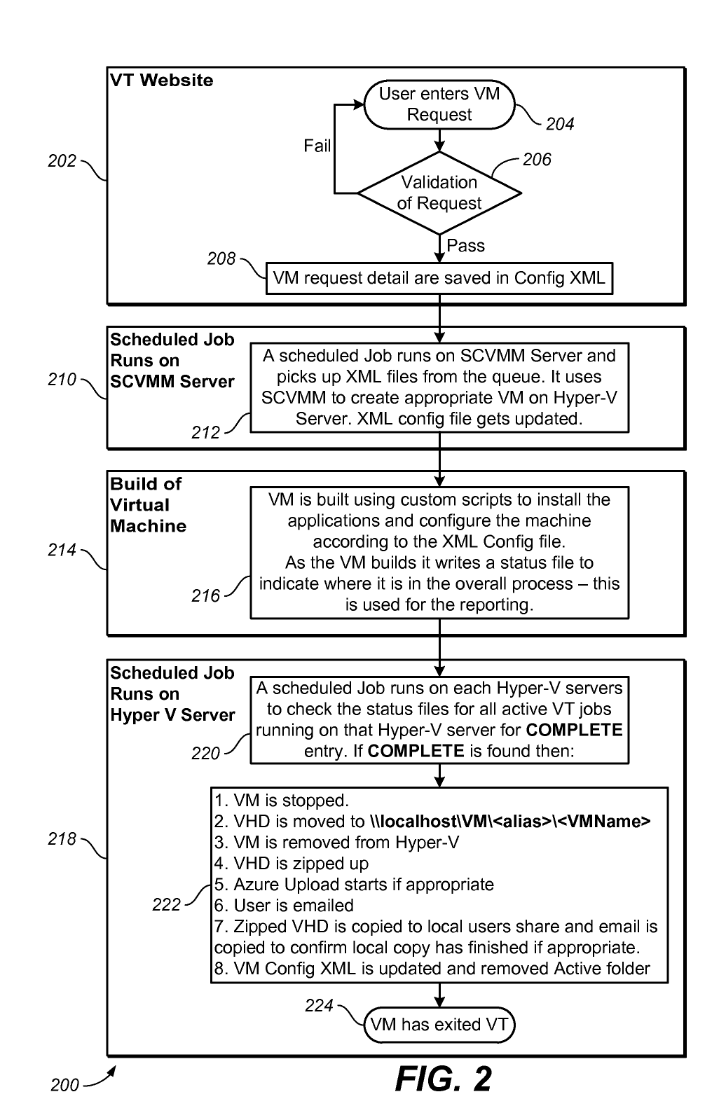

FIG. 2 depicts one embodiment of a flowchart affecting a VT system as made in accordance with the principles of the present application. VT website process (202) starts by receiving user VM requests at 204. The request is validated at 206 and if the user has entered a valid request (depending upon a number of factors, e.g., that the particular VM is realizable according to VT parameters), then the VM request details are saved at 208 by the VT system. These details may be captured in a configuration file—e.g., a Config file in XML—or any other suitable file and/or document. Such information in a suitable configuration file may comprise user-supplied information regarding the VM to be built and possible other information in the VM request.

VT system may then schedule a job run on the VMM server (210). The VM request details may be retrieved and a job run is scheduled on the VMM server at 212. At this point, the VT system may create an appropriate VM on a Hyper-V server or the like. The VT system may additionally update the Config file for proper handling.

To build the VM (214), the VT system may employ custom scripts to build the VM at 216 and configure the VM according to the Config file or any other requested specification. As the VM is being built, the VT system may write to a status file to indicate to the user where the VT system is in the process of building the VM.

A job may be scheduled (218) on the Hyper-V server or the like. At 220, a scheduled job may run on the Hyper-V server (or on each Hyper-V server comprising the VT system) to check the status files for all active VT jobs.

If a VM is complete, then a number of steps may be taken by the VT system at 222. For example, the VM and its build may be stopped. A VHD may be moved to a location that may be accessible to the user. In addition, the VHD may be zipped. The VM may be removed from the Hyper-V server where it resided. The User is also notified that the VM build is complete and now available.

In addition, the VHD (as possibly zipped) may be copied to a local users share and an email is sent to confirm the local copy has finished. The Config file associated with the particular VM build may also be updated and removed from the VT system's “active” folder.

### User Menus, Options and Interface Embodiments

In one embodiment, it may be desirable to present the user with a simple and intuitive set of menus and options to ease the process of creating a VM for the user.

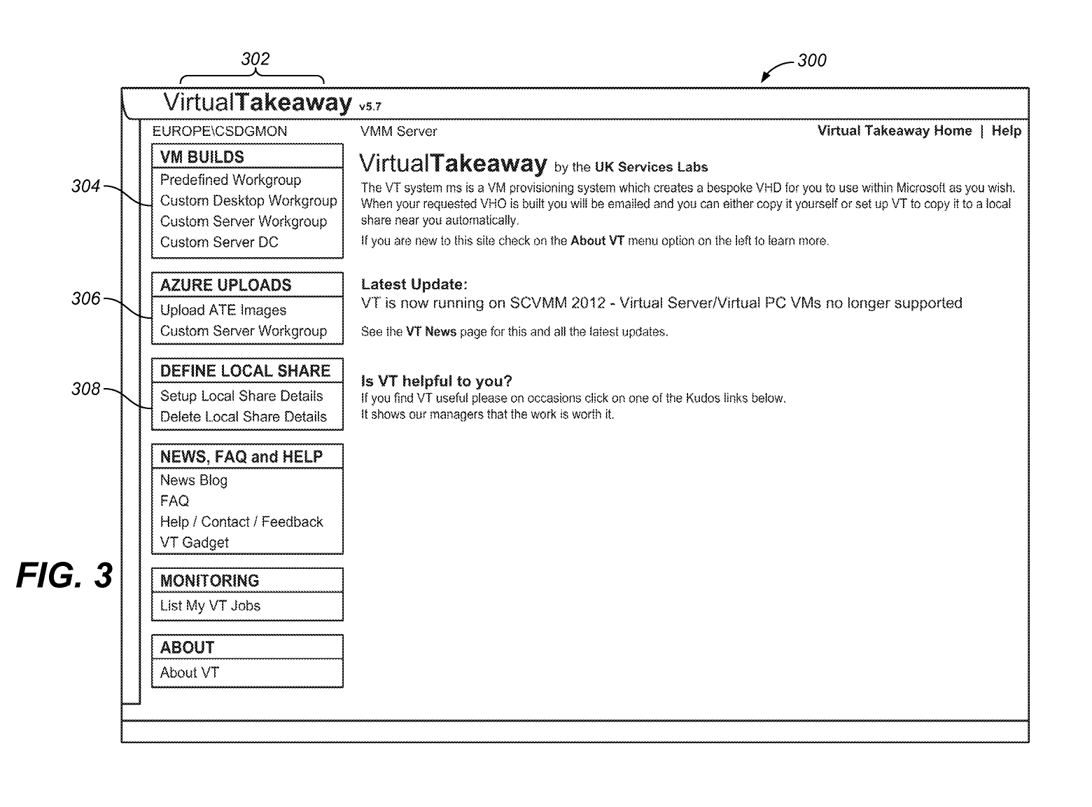

FIG. 3 is one embodiment of a main menu 300 that the VT system might present to the user. The main menu may be partitioned in a friendly and intuitive manner—e.g., the VT menu and/or user commands and options 302 may be presented—for example, on one side of the user screen (e.g., left side, as shown in FIG. 3). Some menu options may include VM Build commands and options 304; upload commands and options 306; local share definition and management 308. Other menu items may include: News, Monitoring (of user VT jobs); and helpful FAQ and About menu items. As may also be seen, menu 300 may include useful information about the status and/or location of the VT system.

Pre-Defined VM Menus and Options

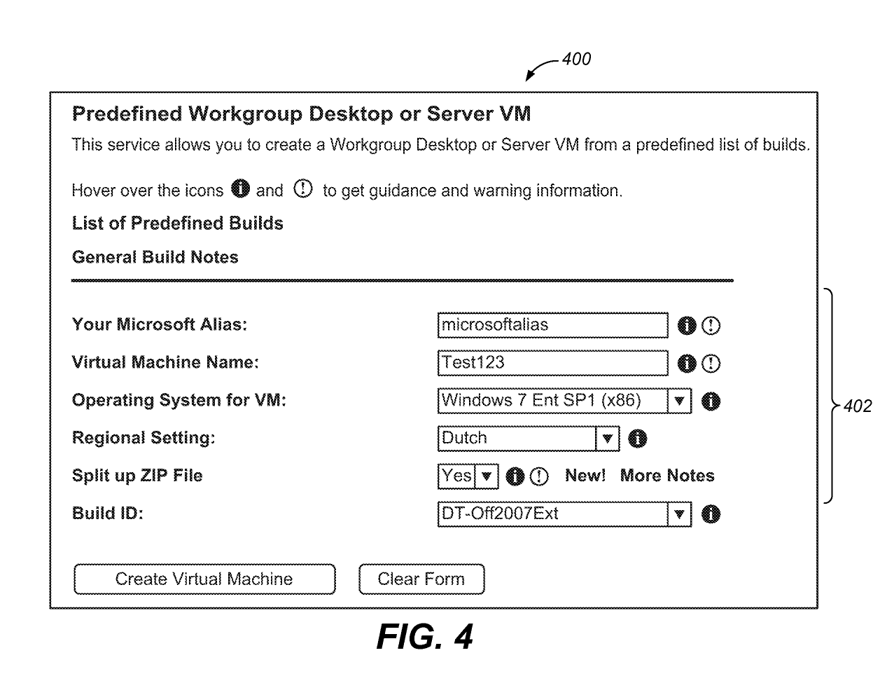

As also seen in FIG. 3, user options for VM builds may include pre-defined, as well as customized, build requests. FIG. 4 depicts one embodiment of a user menu (400) for building pre-defined VMs. As may be seen, the menu may be very simple and intuitive—with a small list 402 of options presented. Such options may include: an alias for the user, a name for the VM under construction, the specification of an operating system for the VM, possible regional data for localization, as well as other identifying information.

When the user presses a submit button (e.g., Create Virtual Machine), the page may execute some validation (e.g. in JavaScript) on the information entered by the user, as mentioned above. If this is valid, then control may be passed to a module, such as CreatePredefinedWG.pwrs.

As part of the validation, the page may check one or more of the following:
(1) The OS the user selected exists in the SCVMM library in the form of a template.
(2) Checks the VM Name is not used in a job in the Queue
(3) Checks the VM Name is not used in an VT active job
(4) Checks the VM Name has not been used in a VT build in the last 6 days
(5) Checks the Microsoft Alias exists in the Active Directory Global Catalogue
(6) Checks whether the VM Name exists in WINS
(7) Checks whether the VM Name exists in DNS
(8) Checks whether the VM Name can be pinged
(9) Checks that the SCVMM OS Template Tag field is not null

If the checks above appear to be valid, then a Config file (e.g., XML file) may be written out—e.g., to a file called D:\VT\Logs\Queue\<Virtual Machine Name>.xml or the like. It will be appreciated that the VT system may check these and other user-supplied information and/or specification for the user's desired VM build against other conditions that disclosed herein.

### Customized VM Menus and Other Options Embodiments

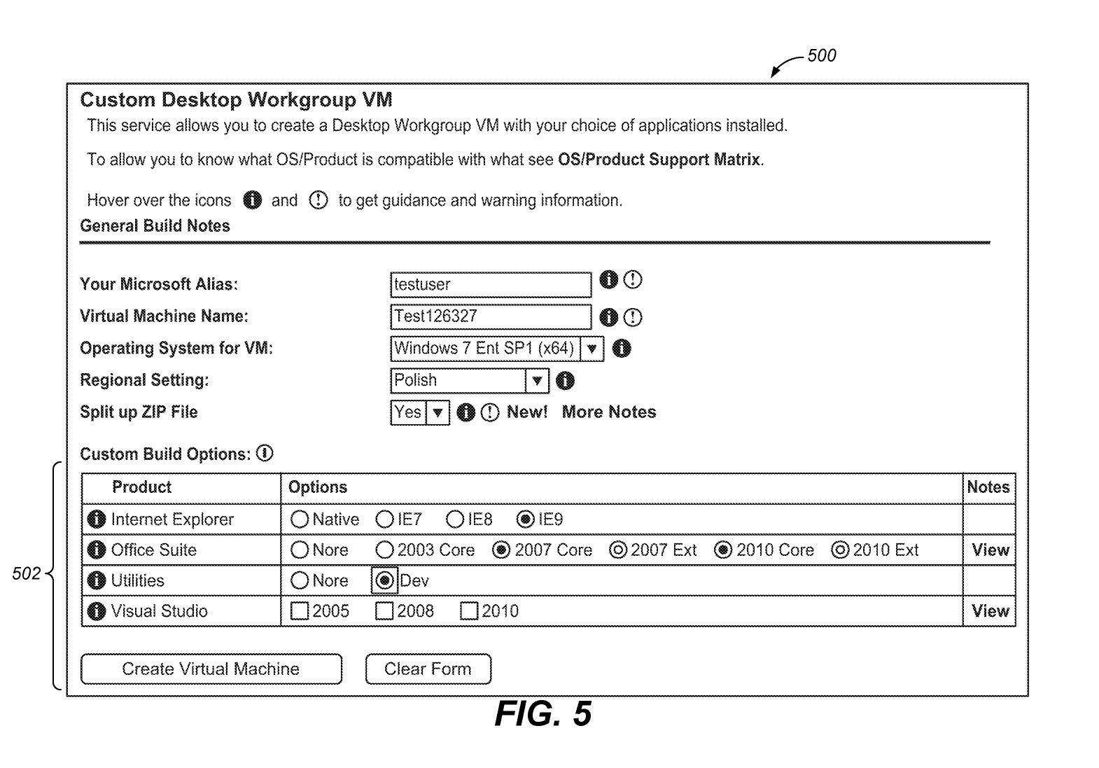

FIG. 5 depicts one embodiment of one user menu screen (500) that may be employed to affect customized VM builds. As with the screen for pre-defined VM builds, the menu options—while more in number—still may be relatively simple and intuitive. The same fields may be shown and presented to the user as in FIG. 4; but, in addition, custom build options may also be presented. These custom build options may include: utilities and services to be installed on the VM, such as which web browser (e.g., Internet Explorer), office/document functionality software (e.g. Office suite), other utilities and Visual Studio modules to be installed in the VM.

As with the discussion above in reference to FIG. 4, the VT system may employ the same checks for validity when the user hits the submit button for a customized build. As the build is customized, there may be additional validity checks, depending on the number of additional options are selectable by the user. VT system may affect the pre-defined VM menus and customized VM menus as modules within the VT controller or elsewhere in the VT system.

In another embodiment, the VT system may allow for Custom Server Workgroup VM builds, or Custom Server Domain Controller VM builds—and options for such custom builds may be offered to the user in a simple and intuitive menu.

The main menu (as shown in FIG. 3) may also allow the option of uploading ATE Images. With this option, the user may be allowed to upload an Test Agent and an Test Controller image (e.g., containing Windows 2008 R2 SP1 with Visual Studio 2010 Test Agent and Controller+Visual Studio 2010 Ultimate respectively) to the Windows Azure platform or any other suitable platform. In one embodiment, these VHD images may be designed to allow a developer to load test an internet facing application. In some embodiments, it may be desirable that no build actually takes place. For example, the images may already exist and are simply uploaded to Azure platform by a script on the VMM server.

### Hyper-V Server Embodiments

In one embodiment, VT system may comprise one or more Hyper-V servers that may be managed by the VT system (e.g., via various scripts). The VT system might apply a script that executes periodically (e.g., every few minutes or so) that may orchestrate all post-APF actions on VHDs and/or perform administrative jobs for the virtualization servers, such as the following:
(1) Shutting down VM through VMM

(2) Copying VHD to Store Folder

(3) Deleting VM through VMM

(4) Zipping up VHD files

(5) Uploading to Azure (or other cloud-based servers)

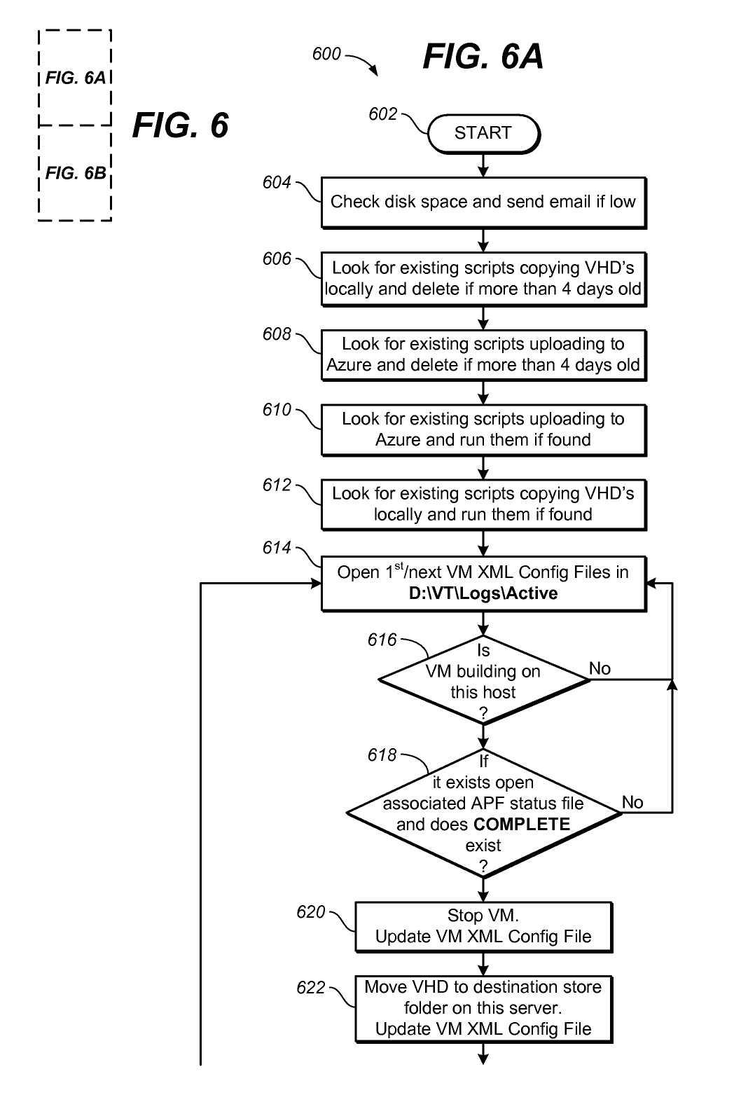

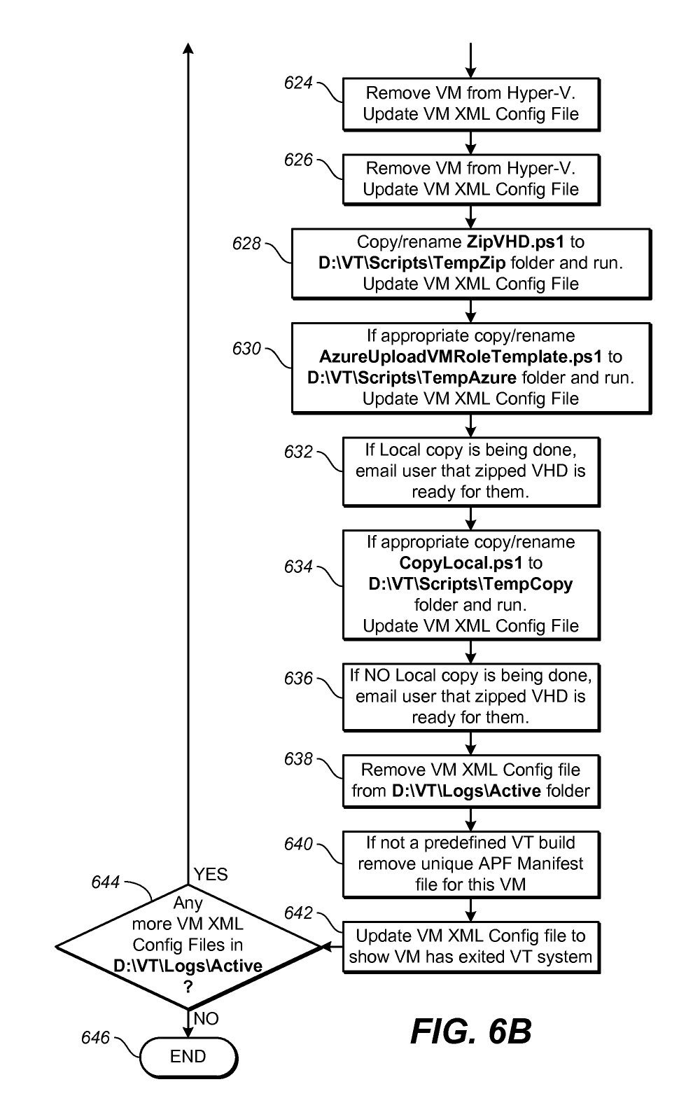

FIG. 6 is one possible VT routine to manage the one or more Hyper-V servers that may comprise the VT system. Routine 600 starts (602) and may perform the following: check disk space (604); delete old scripts copying VHDs locally (606); delete old scripts uploading to Azure (608); run existing scripts uploading to Azure (610); run existing scripts copying VHDs locally (612).

VT routine may perform a comprehensive routine (step 614 to step 644) to actively manage the queue of active VM builds (as may be found in a set of Config files maintained by the VT system. It will be appreciated that additional processing steps may be desirable and a different arrangement of steps may be suitable for the purposes of the present application. Such VT routine may be affected by an administration module within the VT controller or elsewhere within the VT system.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A method for creating virtual machines (VMs) from user requests to a VT system, said VT system comprising a user interface, a set of virtualization servers, and a VT controller for controlling VM build processes within said VT system, the steps of said method comprising:
receiving a user request for a VM build;
checking the validity of said user request for said VM build;
scheduling said VM build job by said VT controller;
building said VM build according to said user request; and
scheduling administrative jobs for said virtualization servers.

2. The method of claim 1 wherein said virtualization servers further comprise one or more Hyper-V servers.

3. The method of claim 1 wherein said step of receiving a user request for a VM build further comprises:
presenting to a user a menu comprising a set of options for a VM built to user's specification.

4. The method of claim 3 wherein the step of presenting to a user a main menu comprising a set of options for a VM built to user's specification further comprises:
presenting to the user a menu comprising a set of options for building a pre-defined VM.

5. The method of claim 4 wherein said set of options for building a pre-defined VM further comprises a set of fields, said fields further comprising one of a group, said group comprising: a user alias, VM name, operating system for said VM, regional setting and build ID.

6. The method of claim 3 wherein the step of presenting to a user a main menu comprising a set of options for a VM built to user's specification further comprises:
presenting to the user a menu comprising a set of options for building a customized VM.

7. The method of claim 6 wherein said set of options for building a customized VM further comprises a set of fields, said fields further comprising one of a group, said group comprising: a user alias, VM name, operating system for said VM, regional setting, build ID, web browser options, office suite options, utilities options.

8. The method of claim 1 wherein said step of checking the validity of said user request for said VM build further comprises:
checking one or more user-supplied specifications for validity against a number of conditions.

9. The method of claim 8 wherein said step of checking one or more user-supplied specifications for validity against a number of conditions further comprises one of a group, said group comprising: checking the OS the user selected exists in the SCVMM library in the form of a template, checking the VM Name is not used in a job in the Queue; checking the VM Name is not used in an VT active job; checking the VM Name has not been used in a VT build in the last 6 days; checking the Microsoft Alias exists in the Active Directory Global Catalogue; checking whether the VM Name exists in WINS; checking whether the VM Name exists in DNS; checking whether the VM Name can be pinged and checking that the SCVMM OS Template Tag field is not null.

10. The method of claim 1 wherein said step of checking the validity of said user request for said VM build further comprises:
creating a configuration file, said configuration file comprising user-supplied information regarding said VM build.

11. The method of claim 1 wherein said step of building said VM build according to said user request further comprises:
updating a status file to indicate where in the process the VM build has occurred.

12. The method of claim 1 wherein said step of scheduling administrative jobs for said virtualization servers further comprises one of a group, said group comprising: shutting down the VM as desired; copying VHD to a store folder; deleting VMs as desired; zipping up VHD files and uploading VM files to cloud platform.

13. A VT system for creating VM from user requests, said system comprising:
a VT website, said VT website capable of presenting users with a main menu of options for a user to select a desired VM to build;
a set of virtualization servers, said virtualization servers capable of building VMs according to the specification supplied by said user; and
a VT controller, in communications with said set of virtualization servers, wherein said VT controller is capable of testing user requests for VM builds and scheduling jobs to affect said VM builds.

14. The system of claim 13 wherein said VT website further comprises a pre-defined VM build module, said pre-defined VM build module capable of presenting to said user a set of pre-defined VM fields.

15. The system of claim 13 wherein said VT website further comprises a customized VM build module, said customized VM build module capable of presenting to said user a set of customized VM fields.

16. The system of claim 13 wherein said system further comprises an administration module for keeping track of the status of VM builds within said VT system.

17. A computer readable storage medium that is not a transient signal, said computer readable storage medium having computer-executable instructions stored thereon that, when executed by a processor, cause said processor to execute: a method for creating virtual machines (VMs) from user requests to a VT system, said VT system comprising a user interface, a set of virtualization servers, and a VT controller for controlling VM build processes within said VT system, the steps of said method comprising:
receiving a user request for a VM build;
checking the validity of said user request for said VM build;
scheduling said VM build job by said VT controller;
building said VM build according to said user request; and
scheduling administrative jobs for said virtualization servers.

18. The computer readable storage medium of claim 17 wherein said step of receiving a user request for a VM build further comprises:
presenting to a user a menu comprising a set of options for a VM built to user's specification.

19. The computer readable storage medium of claim 18 wherein the step of presenting to a user a main menu comprising a set of options for a VM built to user's specification further comprises:
presenting to the user a menu comprising a set of options for building a pre-defined VM.

20. The computer readable storage medium of claim 18 wherein the step of presenting to a user a main menu comprising a set of options for a VM built to user's specification further comprises:
presenting to the user a menu comprising a set of options for building a customized VM.
